(19) United States
(12) Patent Application Publication
(10) Pub. No.: US 2011/0049955 A1
(43) Pub. Date: Mar. 3, 2011

(54) Backrest adjusting structure of baby stroller

(76) Inventor: Pao-Hsien Cheng, Jen Te Hsiang (TW)

(21) Appl. No.: 12/585,018

(22) Filed: Sep. 1, 2009

(51) Int. Cl. B62B 9/12; B62B 9/00

(52) U.S. Cl. 297/354.12

(57) ABSTRACT

This invention relates to a backrest adjusting structure of baby stroller in which a seat-rod frame is essentially provided between two opposite main stand bodies and a backrest structure enabling angle adjustment is assembled on the seat-rod frame, the backrest structure having an adjusting belt body penetrating through a back plate, one ends of a first and a second belt bodies included in the adjusting belt body being combined with the main stand bodies, further a position-fixing member being provided on the back plate to fix the adjusting belt body. In this manner, in the state of re-adjusting the expansion and contraction of the adjusting belt body by the backrest support rods, the angle of the backrest of baby stroller can be adjusted according to demand so as to achieve the effectiveness of ease in use.

### BACKGROUND OF THE INVENTION

1. Field of the Invention

The present invention relates to a backrest adjusting structure of baby stroller, especially to a backrest adjusting structure of baby stroller in which the adjusting belt body is pulled, so that the backrest is linking-up to conduct the displacement for angle adjustment.

2. Brief Description of the Prior Art

Usually, parents use auxiliary means such as swing bed, baby walker for infant to play and learn so as to assist the care of infant at home. When taking infants to outdoor, baby stroller becomes the most effective means, because on one hand there is no need to embrace infant for a long time, and on the other hand the safety of taking infant to outdoor can be well noticed. Thus, how to choose a suitable baby stroller is very important, as it is the first “car” for the children which will accompany with children to go through the initial grow-up stage.

Currently, there are a variety of kinds of baby stroller sold on market, which are classified according to appearance, style, function, safety, and material. However, function and safety are still the key item which parents care about the most. The function of baby stroller is different for each style, but key safety points such as: whether the support rods of baby stroller is stable or not, whether the backrest can back up the spine of infant or not, whether there is a safety belt and shoulder belt to fasten the infant so as to avoid infant baby from crawling out from the stroller or not, whether there is gap around the baby stroller or not so as not to clip the small hands of infant baby, are well watched.

Furthermore, use and operation, such as total shrinkage, backrest angle adjustment or wheel alignment, have still to be taken into further consideration. As to the function and operation of backrest adjustment, usually concerned members have to be pulled by both hands so as to adjust and to displace the backrest in order to achieve the effect of backrest angle adjustment. Thus, something inconvenient and unsatisfactory is happened in operation.

In view of the above disadvantages, the inventor of the present invention, according to the improvement conducted on defects of the existing structure based on his abundant experience of R&D and manufacturing in relevant field, provides a backrest adjusting structure of baby stroller in which the effect and advantage of adjusting the backrest angle is achieved by the easy method of single hand operation so as to improve all the disadvantages of prior art structure.

### SUMMARY OF THE INVENTION

The main object of the present invention is to improve the disadvantages of conventional structure so as to achieve the effect of adjusting the elevation angle of the backrest of baby stroller by easily pulling the adjusting belt body to move.

The object and effectiveness of the backrest adjusting structure of the present invention can be achieved by the following technology:

A seat-rod frame is essentially provided between two opposite main stand bodies and a backrest structure enabling angle adjustment is assembled on a seat-rod frame, the backrest structure having adjusting belt body penetrating through a back plate, one ends of a first and a second belt bodies included in the adjusting belt body being combined with the main stand bodies, further a positioning member being provided on the back plate to fix the adjusting belt body. In this manner, in the state of re-adjusting the expansion and contraction of the adjusting belt body by the backrest support rods, the angle of the backrest of baby stroller can be adjusted according to demand so as to achieve the effectiveness of ease in use.

### BRIEF DESCRIPTION OF ACCOMPANYING DRAWINGS

FIG. 1 is a perspective outline schematic view showing the backrest adjusting structure of baby stroller of the present invention.

FIG. 2 is a perspective outline view showing the action of the backrest adjusting structure of baby stroller of the present invention.

FIG. 3 is a partial enlarged schematic view showing the backrest adjusting structure of baby stroller of the present invention.

FIG. 4 is a partial enlarged schematic rear view showing the backrest adjusting structure of baby stroller of the present invention.

FIG. 5 is a schematic view showing the position-fixing member of the present invention.

FIG. 6 is a schematic view showing the action of the position-fixing member of the present invention.

### DETAILED DESCRIPTION OF PREFERRED EMBODIMENTS

The objects, the technical contents and the expected effectiveness of the present invention will become more apparent from the detailed description of the preferred embodiment in conjunction with the accompanying drawings.

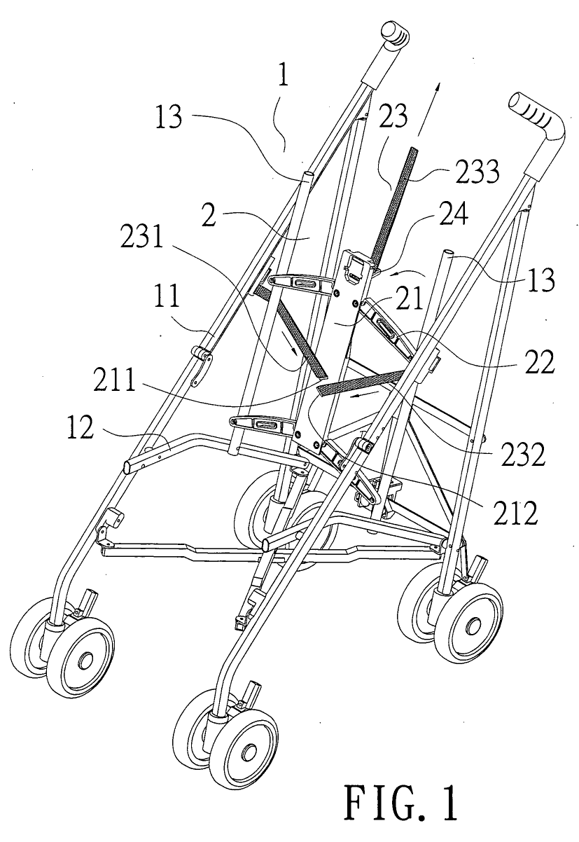

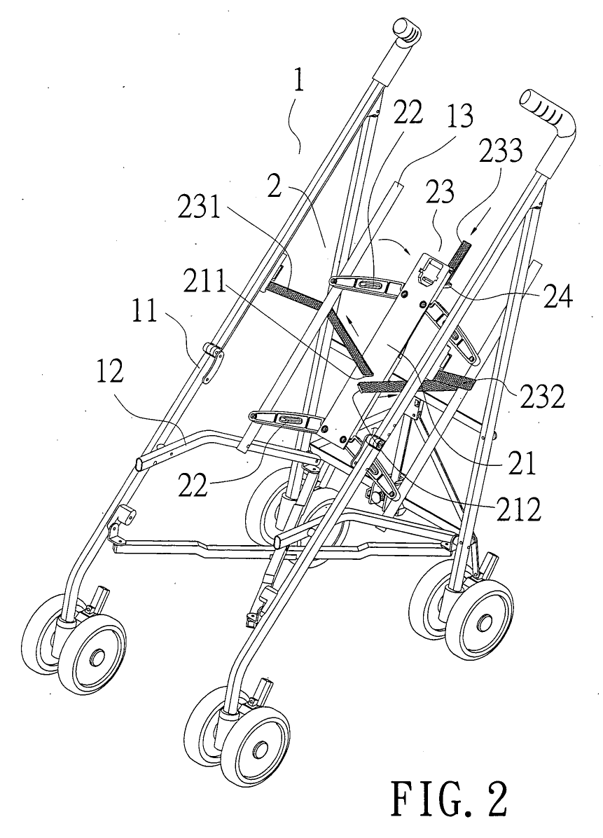

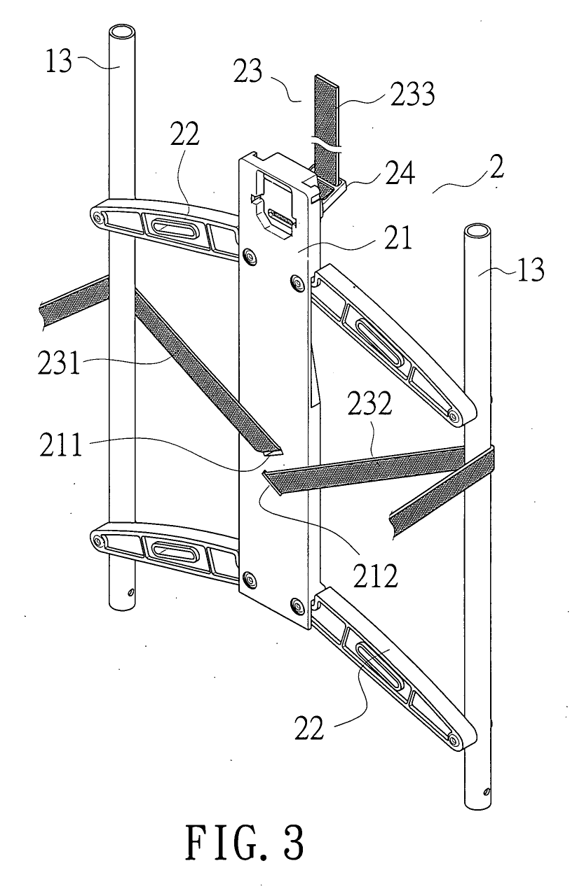

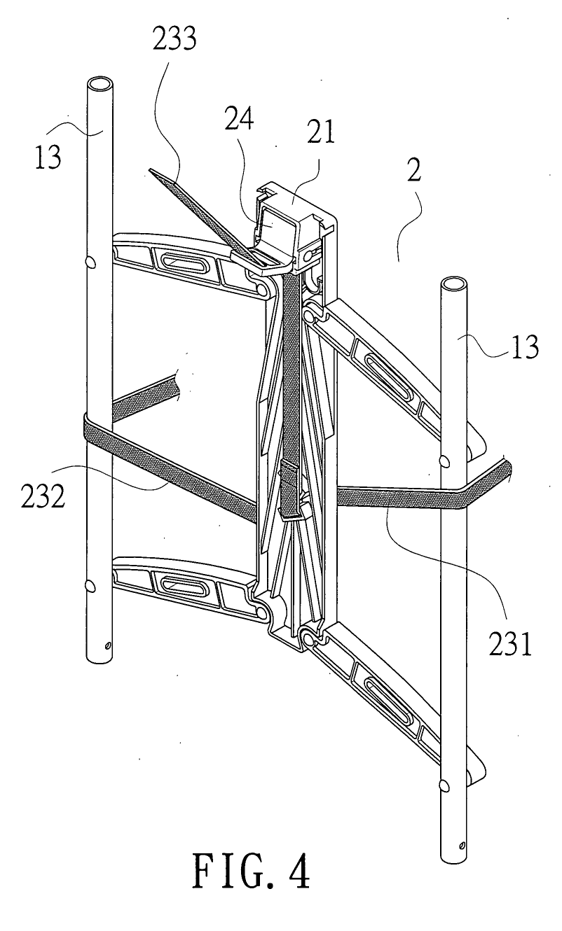

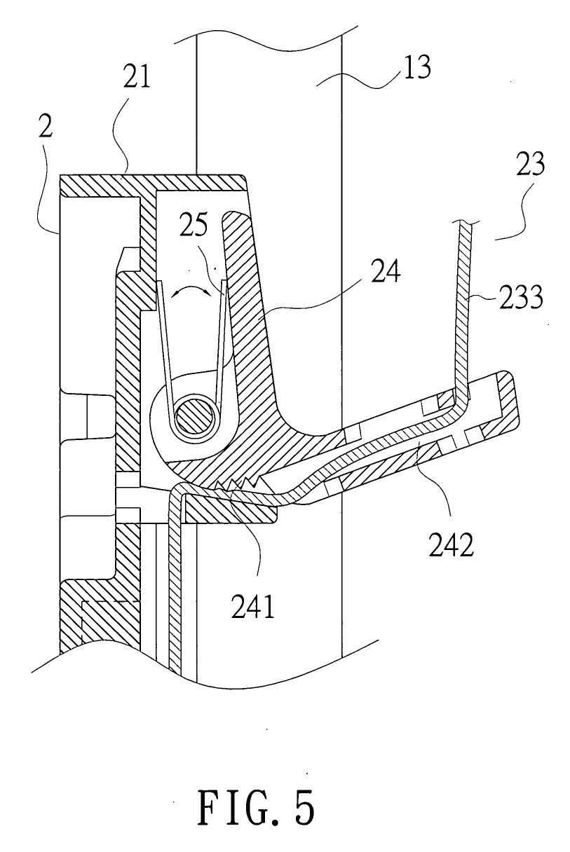

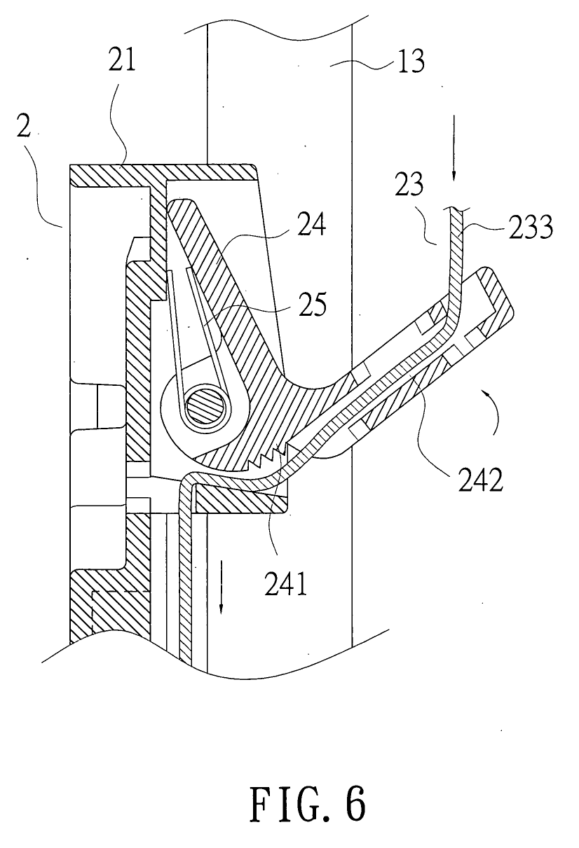

Firstly referring to FIG. 1 to 6 showing respectively the total outline and partial enlarged and action schematic view of the backrest adjusting structure of the present invention, the baby stroller (1) is essentially provided with a seat-rod frame (12) disposed between two opposite main stand bodies (11) at each side. Support rods (13) are pivotally provided on the seat-rod frames (12) and a backrest structure (2) enabling angle adjustment is assembled on the support rods (13). The backrest structure (2) comprises:

a back plate (21) the end surface of which is provided with a left and a right through holes (211), (212), and the back surface of its top end is provided with a belt-out slot (213);

a plurality of support members (22) which are connected between the support rods (13) and the back plate (21);

an adjusting belt body (23) having a first and a second belt bodies (231), (232) passing through the left and a right through holes (211), (212) respectively and being fixed with their positions on the main stand bodies (11), while the other ends of the first and a second belt bodies (231), (232) being converged as one third belt body (233) which penetrates out from the belt-out slot (213) on the back plate (21);

a position-fixing member (24) assembled near the belt-out slot (213) of the back plate (21) and a torsional spring (25) being inserted on the position-fixing member (24), canine teeth (241) being provided on the position-fixing member (24) and a passage (242) being provided to link at the rear end of the canine teeth (241) for the penetration-out of the third belt body (233).

In this manner, in the state of re-adjusting the expansion and contraction of the adjusting belt body (23) by the backrest support rods (13), the angle of the backrest of baby stroller can be adjusted according to demand so as to achieve the effectiveness of ease in use.

Referring to FIG. 1 to 6, in assembling process, the back plate (21) is firstly coupled on support rods (13) of the main stand bodies (11) through the support members (22). In turn, the first and a second belt bodies (231), (232) of the adjusting belt body (23) are penetrated through the left and a right through holes (211), (212) of the back plate (21) respectively and are fixed with their positions on the main stand bodies (11) after turning around the back of the support rods (13) respectively. Then, the third belt body (233) is penetrated out from belt-out slot (213) at the back surface of top end of the back plate (21) and is located under the canine teeth (241) of the position-fixing member (24), finally is led out through the passage (242). The shaft for assembly of the position-fixing member (24) is inserted with a torsional spring (25). When the backrest is yet unadjusted, the torsional spring (25) urges the position-fixing member (24) to rotate downwardly so that the canine teeth (241) of the position-fixing member (24) gnaws into the third belt body (233) of the adjusting belt body (23), which is fixed in position to avoid from being pulled. Thus, the adjusting belt body (23) is kept at a certain length and the angle of the back plate (21) is not adjusted to produce displacement.

When the angle of the backrest is to be adjusted, the position-fixing member (24) is rotated upwardly so that the torsional spring (25) is compressed. Then, the canine teeth (241) of the position-fixing member (24) is separated from the gnawing with the third belt body (233) of the adjusting belt body (23). In turn, the third belt body (233) of the adjusting belt body (23) is pulled to move, which is linking-up with the first and a second belt bodies (231), (232). When the first and a second belt bodies (231), (232) is pulled to reduce the length extended to the main stand bodies (11), the support rods (13) is moved to generate displacement which allows the back plate (21) to be linking-up to conduct angle adjustment. In this manner, in the state of re-adjusting the expansion and contraction of the adjusting belt body (23) by the backrest support rods (13), the angle of the backrest of baby stroller can be adjusted according to demand so as to achieve the effectiveness of ease in use. After the adjustment is finished, the position-fixing member (24) is released to allow the torsional spring (25) to restore so that the position-fixing member (24) is rotated downwardly to fix the adjusting belt body (23) in position so as to avoid from being pulled.

While the present invention has been described by the above preferred embodiment, it is noted that the above preferred embodiment is not used to restrict the product structure or usage mode of the present invention. Variations and modifications made without departing from the spirit and features of the present invention are still considered to be within the scope of the present invention.

Based on the foregoing, the backrest adjusting structure of baby stroller of the present invention has the following advantages when comparing with the structure of conventional stuff.

1. The backrest adjusting structure of baby stroller of the present invention can pull the adjusting belt bodies, which turn around the two support rods (13), by single hand such that the length of the belt body can be shrunk to change the angle of the support rods as well as the back plate. Therefore, the advantages and effectiveness of adjusting the backrest angle by single hand can be achieved.

2. In the backrest adjusting structure of baby stroller of the present invention, the adjusting belt body is pulled so that the backrest is linking-up to conduct displacement for angle adjustment. Therefore, the backrest of baby stroller can adjust its desired angle according to demand so as to achieve the effectiveness of ease in use.

What is claimed is:

1. A backrest adjusting structure of baby stroller, in which a seat-rod frame is essentially provided between two opposite main stand bodies, support rods being pivotally provided on the seat-rod frames and a backrest structure enabling angle adjustment being provided on said back plate, wherein:
said backrest structure has an adjusting belt body having a first and a second belt bodies passing through the left and a right through holes and being fixed with their positions on the main stand bodies respectively, while the other ends of the first and a second belt bodies being converged as one third belt body which penetrates out from a belt-out slot of the back plate; a position-fixing member having a canine teeth thereon being assembled near the belt-out slot and a torsional spring for restoring being inserted on the position-fixing member, a passage being provided to link at the rear end of the canine teeth of the position-fixing member so as to provide for the penetration-out of the third belt body.

2. A backrest adjusting structure of baby stroller as claimed in claim 1, wherein said back plate is coupled to the support rods by a plurality of support members.
